(19) United States
(12) Patent Application Publication
(10) Pub. No.: US 2025/0257520 A1
(43) Pub. Date: Aug. 14, 2025

(54) AUTOMATIC CLOTHES FOLDING MACHINE

(71) Applicants: Shengjun Wang, Cypress, CA (US); Jamie Juan, Cypress, CA (US); William Shen, Cypress, CA (US); Thomas Shen, Cypress, CA (US)

(72) Inventors: Shengjun Wang, Cypress, CA (US); Jamie Juan, Cypress, CA (US); William Shen, Cypress, CA (US); Thomas Shen, Cypress, CA (US)

(21) Appl. No.: 18/949,438

(22) Filed: Nov. 15, 2024

Related U.S. Application Data
(60) Provisional application No. 63/551,345, filed on Feb. 8, 2024.

(51) Int. Cl. D06F 89/02; B25J 9/16

(52) U.S. Cl. CPC D06F 89/026; B25J 9/1697

(57) ABSTRACT

A machine, comprising an enclosure, three or more robotic arms each having one end connected to a top panel of the enclosure and an opposite end connected a hand configured to grab and release one or more clothing items, two or more baskets for storing the clothing items, a folding platform above the baskets, a processor, and an artificial intelligence system. The processor is configured to control movement of each of the robotic arms, while the artificial intelligence system is configured to identify each item grabbed by at least one of the robotic arms. The folding platform folds the clothing item based on the type identified by the artificial intelligence system.

### BACKGROUND

Clothes folding is a trivial and time-consuming task for every household. This trivial and frequent work also demands significant labor in industries such as hotels, hospitals and clothing retails. Various machines have been developed to fold clothes automatically. However, none has been satisfactory to automatically pick and fold a clothing item from a load of multiple clothing items without human interaction.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view showing an enclosure of an automatic clothing folding machine according to some embodiments.

FIG. 2 shows the interior wall of the top panel of the enclosure of the clothing folding machine and a folding mechanism mounted to the interior wall of the top panel;

FIG. 3 shows the folding mechanism in an idle or off state according to some embodiments

FIGS. 4-6 shows the folding mechanism in an active state according to some embodiments;

FIG. 7 is a flow chart of a method for picking and sorting clothing items from a basket according to some embodiments;

FIG. 8 is a flow chart of a method for identifying a clothing item according to some embodiments;

FIG. 9 is a flow chart of a method for folding a clothing item according to some embodiments;

FIG. 10 shows a modification of the method as shown in FIG. 9 according to some embodiments;

FIG. 11 is a flow chart of a method for folding a specific type of clothing according to some embodiments;

FIG. 12 shows a clothing item placed on a folding platform ready to be folded according to some embodiments;

FIG. 13 shows another type of clothing item placed on a folding platform ready to be folded; and

FIGS. 14 and 15 show another embodiment of the folding machine according to some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “on,” “top,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

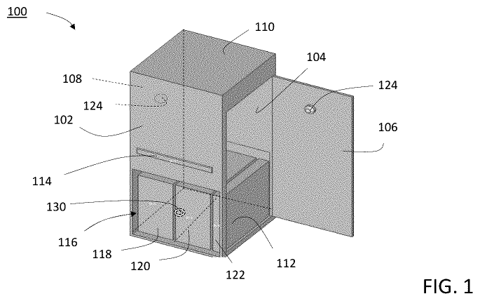

FIG. 1 is a perspective view of an enclosure of an automatic clothing folding machine 100. As shown in FIG. 1, the enclosure defines a cavity to provide the working space for folding clothing items. The enclosure is constructed by six panels, including a front panel 102, a rear panel 104, a pair of side panels 106 and 108 (outlined by dash lines), a top panel 110, and a bottom panel 112 (outlined by dash lines). The six panels 102 to 112 have rectangular shapes and are orthogonal to each other to form the enclosure in a rectangular prism shape. It will be appreciated that the panels 102 to 112 may be in other shapes such that the enclosure may be formed in other shapes that may provide similar clothing functions as the rectangular configuration. According to some embodiments, the front panel 102 includes a display unit 114 and an opening 116 at a bottom portion thereof. At least one basket can be drawn into and out from a lower portion of the cavity inside the enclosure of the clothing folding machine 100. According to some embodiments, three baskets 118, 120, and 122 may be inserted into the lower portion of the folding machine 100 in parallel. These three baskets 118, 120, and 122 may be drawn to any desired portions individually without interfering the operation of the others.

According to some embodiments, the basket 118 may be designated as an input basket where unfolded clothes may be disposed. The basket 120 may be designated as an output basket where the clothes that have been folded may be disposed. The basket 122 may be relatively smaller than the baskets 118 and 120 and may be designated to accommodate indiscernible articles or items, for example, some clothing items that cannot be properly folded by the folding machine 100. The functions of the baskets 118 and 120 may be exchanged as desired. The sizes of the baskets 118, 120, and 122 may also be modified according to specific need.

The display unit 114 provides the information of the folding operations in the cavity. For example, the display unit 114 may show signs, symbols, or words indicating whether the folding operation is ongoing, completed, or to be started. Other information such as the number of clothing items in any of the baskets 118, 120, and 122 may also be shown by the display unit 114. The display unit 114 may also provide a warning message when the folding operation is suspended due to known or unknown reasons.

The side panels 106 and 108 may include cameras or image sensors 124 mounted to the respective interior sides thereof. As shown in FIG. 1, the cameras 124 are positioned to image from the middle portion of the cavity above the baskets 118, 120, and 122. In some embodiments, the cameras 124 include wide-angle visions of the cavity at two opposite directions, such that the images of the clothing items disposed anywhere in the cavity can be captured and identified. The cameras 124 may also be oriented with a desired angle to sense or capture images in a specific direction. The folding status of the clothing items can also be monitored by the cameras 124. The cameras 124 may provide the images of the clothing item(s) that is subject to the folding process.

In some embodiment, the cameras 124 may be repositioned by some moving mechanisms. For example, a horizontal track and/or a vertical track along which the cameras 124 may be moved may be installed on the interior wall of each of the side panels 106 and 108. Each of the front panel and the rear panel may also include one or more cameras 124 at the interior wall thereof according to some embodiments. In addition to the cameras 124 and 126, a sensor 130 may be installed on the interior wall of the bottom panel 112 and under the basket 118. The sensor 130 may include a weight sensor to detect the loading condition of the basket 118. More than one sensor 130 may be installed to detect the loading condition of the baskets 120 and 122 according to some embodiments.

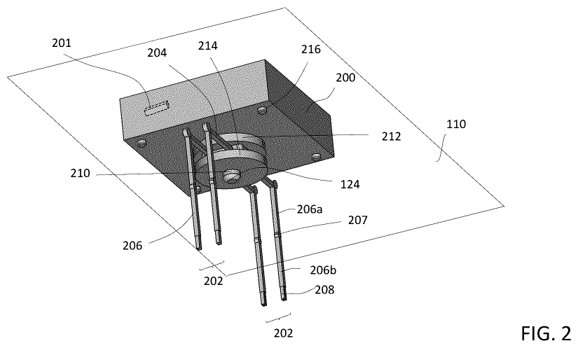

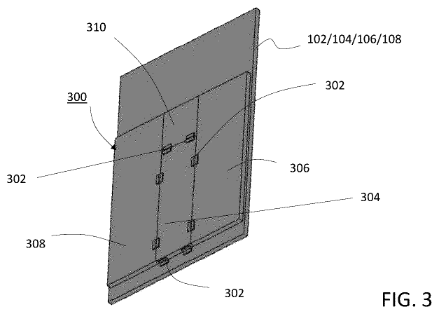

FIG. 2 shows the clothing picking and folding mechanism and the driving mechanism of the picking and folding mechanism. As shown in FIG. 3, the picking and folding mechanism includes multiple robotic arms 202 for picking, selecting, and folding the clothing items in the cavity within the clothing folding machine 100. The driving mechanism includes a pivot, a shaft, or a pin 210, a proximal dish 212 mounted to the interior wall of the top panel 110, and a distal dish 214 arranged in parallel with the proximal dish 214. Both the proximal and distal dishes 212 and 214 may have circular shapes as shown in FIG. 3. It will be appreciated that the proximal and distal dishes 212 and 214 may be in other shapes according to specific needs. The pivot 210 extends through the center of the proximal dish 212 to the distal dish 214 to drive the robotic arms 202. According to some embodiment, a box 200 in or on which wires, motor, and other devices or components such as a processor, a motherboard, a minicomputer, a network connector, or even a motor to drive and driving mechanism may be mounted to the top panel 110. Alternatively, the top panel 110 may include a hollow structure to replace the box 200.

Referring to FIG. 2, each of the robotic arms 202 includes an upper arm 204 extending along a horizontal direction under the top panel 110 and a forearm 206 extending along a vertical direction in the cavity in the folding machine 100. Each of the upper arms 204 has a proximal end connected to the pivot 210 between the proximal dish 212 and distal dish 214. The pivot 210 may be connected to and driven by a motor or other mechanisms to spin or rotate. The motor may also supply a force to cause the upper arms 204 to extend away or retract toward the pivot 210. Each upper arm 204 has a distal end connected to a top end of the corresponding forearm 206 which extends or retracts vertically therefrom. The forearm 206 may extend into or retract away from the baskets 118, 120, and 122. The bottom end of each of the forearm 206 has a hand, which may include at least two fingers 208 for grabbing, retaining, and releasing the clothing items to and from each of the baskets 118, 120, and 122.

In some embodiments, the fingers 208 operate in a pincer-like alignment motorized to enable opening and closing motions. Both the upper arms 204 and the forearm 206 may be hollow to allow wirings connected to a motor and each of the fingers 208. Each of the upper arms 204 and the forearm 206 may include a telescope tubing structure to extend or retract as desired. The telescope tubing may include multiple sectors telescoped with each other. For example, as shown in FIG. 2, each of the forearms 206 includes two sectors 206a and 206b telescoped with each other at a joint 207. The fingers 208 may be straight or curved with two distal ends in direct contact with each other while the hand is driven in the close state. In some embodiments, the hand may include more than two fingers 208. In more sophisticated designs, the hand may include 5 fingers functioning like a human hand.

According to some embodiments, lighting devices may be mounted to the interior wall of the top panel 110. For example, referring to FIG. 2, a lighting device 216 may be installed at each of four corners of interior wall of the top panel 110. The lighting device 216 may also be installed on the lower surface of the distal dish 214. The lighting devices 216 project light on the clothing items, the interior space of each of the baskets 118, 120, and 122, such that the images of the clothing items and the interior spaces of the baskets 118, 120, and 122 can be clearly captured by the cameras 124. In addition to the cameras 124 mounted at the interior walls of the front panel 102, the rear panel 104, and the side panels 106 and 108, additional camera 124 may also be installed at the interior wall of the top panel 110. For example, as shown in FIG. 2, a camera 124 is installed at the pivot 210.

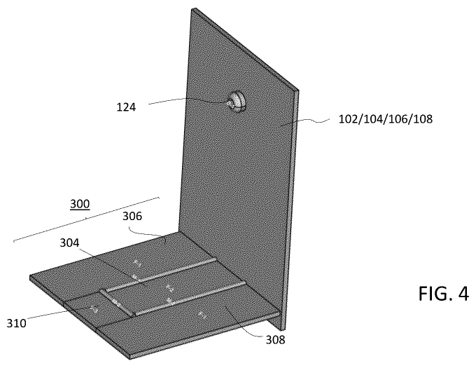

The folding machine 100 further includes a folding platform 300 with a rear end hinged with one of front panel 102, the side panels 106, 108, or the rear panel 104 and a front end opposite to the rear end free. The front end is a free end unattached to any fixture as shown in FIGS. 3-6. When the folding machine 100 is switched off or in an idle state, the folding platform 300 may be automatically or manually flapped or swung upwardly to an upright position with a folding surface facing the interior wall of the front panel 102, the side panel 106, 108, or the rear panel 104 as shown in FIG. 4. The folding platform 300 further includes a central board 304, two side folding boards 306 and 308 hinged with the central board 304 at two opposites thereof, and a front folding board 310 hinged with the central board 304 at a front edge thereof.

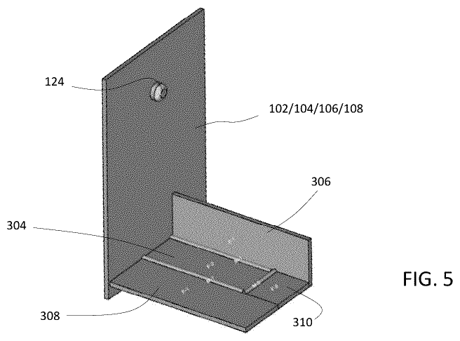

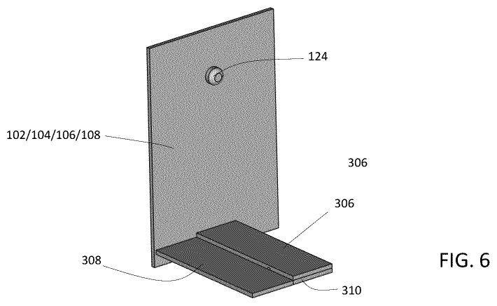

To allow the side folding boards 306 and 308 to swing between a side-by-side position as shown in FIG. 4, an upright position (see the side folding board 306 as shown in FIG. 5), and an overlapping position with the central board 304 (see the side folding board 306 as shown in FIG. 6), hinges 302 or other hinge or pivot mechanisms may be used to allow the side folding bards 306 and 308 to swing with a maximum angle of about 180°. Similarly, the front folding board 310 may also be connected to the front edge of the central board 304 by the hinges 302 or other hinge devices. In addition, the folding platform 300 may be hinged with the side panel 106, 108, or the rear panel 104 by the hinges 302 located at the edges of the central board 304 only to allow the folding motion of the side folding boards 306 and 308. Therefore, when a clothing item is disposed on the folding platform 300, two side portions and one end portion of the clothing item may be folded to overlap with the central portion of the clothing item to result in a rectangular folded clothing item.

In the embodiment as shown in FIGS. 3-6, each of the side folding boards 306 and 308 has a length approximately the same as the sum of the length of the central board 304 and the front folding board 310. The sum of the widths of the front folding board 310 and both side folding boards 306 and 308 is smaller than the width of the side panel 106, 108, or the rear panel 104 to which the folding platform 300 is attached. When the folding machine is in an operation mode, that is, to fold a clothing item, the folding platform 300 is flapped downward to a horizontal plane perpendicular to the side panels 106 and 108 as shown in FIG. 5.

According to some embodiments, the surface of each of the central board 304, the side folding boards 306 and 308, and the front folding board may be roughened or coated with a rough surface allowing fabric or materials of the clothing items from slipping away from the surface during the folding operation.

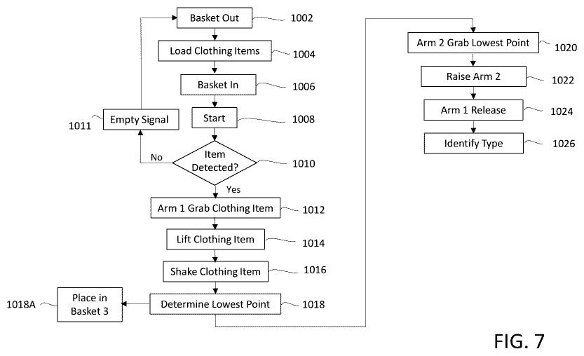

FIG. 7 is a block diagram showing various steps of a method to pick clothing items from the input basket 118 and place the folded clothing item into the output basket. At block 1002, the input basket 118 is drawn open from the folding machine 100. The input basket 118 may be completely drawn away from the folding machine 100 or partially moved out of the folding machine 100 with its rear portion remaining in the folding machine 100. At block 1004, clothing items may be loaded in the input basket 118. One or multiple clothing items may be placed in the input basket 118 simultaneously or at different times. Once loaded with the clothing items, the input basket 118 is drawn back inside the folding machine 100 at block 1006. According to some embodiments, the user may manually push a start button to start the folding operation at block 108. The start button may include a switch located at the front panel 102 (or any of the side panel 106, 108, and rear panel 104) of the folding machine 100. According to some embodiments, the start button may include a touch icon shown on the display unit 114 that the user may simply touch or press the icon on the display unit 114 to start the folding operation. Before picking up any clothing items, whether the input basket is loaded with any clothing item is detected at block 1010.

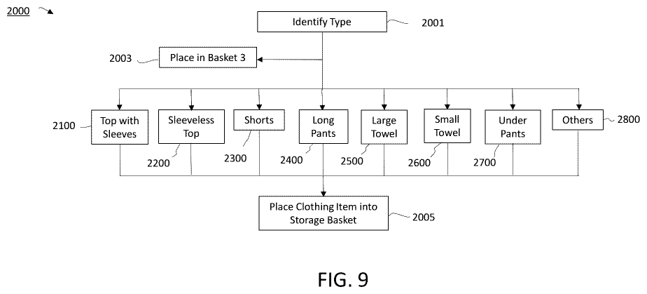

In some embodiments, when the input basket 118 resumes to its close position inside the folding machine 100 from an opening position, the open/close operation of the input basket 118 may be detected to generate an empty signal that may be delivered to a controller (see 300 as shown in FIG. 9) to start the folding operation of the folding machine 100 without the manual operation of the user. The empty signal may be detected from the cameras 124, 126, or other types of sensors such as a weight sensor 130 located under the input basket 118. That is, when the folding machine 100 is switched to a full automatic mode, the folding operation may be automatically activated upon closing motion of the input basket 118. Under the full automatic mode, the block 1008 is unnecessary since the folding operation may start automatically upon the close motion of the input basket 118. The full automatic mode and the manual start mode may be implemented by the touch icons displayed on the display unit 114 one the folding machine 100 is powered on. When it is determined that the input basket 118 is empty, the empty signal is generated and displayed at block 1011 and the process flows back to the beginning step of the method. In some embodiments, the empty signal may also be presented by a warning sound. For example, a sound icon may be displayed by the display unit 114 together with other touch icons as shown in FIG. 9. The sound may be switched off by pressing the sound icon.

When clothing items are detected in the input basket 118, at block 1012, a first robotic arm 202 (Arm 1) is driven to stretch into the input basket 118 and grab the clothing item(s) with its fingers 208 at block 1012. At block 1014, Arm 1 retracts to a highest level, that is, a position closest to the top panel 102, to lift the clothing items to a range where the cameras 124 may take a full picture of the clothing items grabbed by Arm 1. At block 1016, Arm 1 shakes the clothing item(s) to loosen portions of the clothing item(s) tangling or stuck with each other. The cameras 124 may then detect the lowest point of the clothing item(s) grabbed by Arm 1 at block 1018. When the lowest point of the clothing item cannot be determined at block 1018, for example, when the dimension of the clothing item is beyond the available space of the operating space, that is, the cavity, the clothing item may be placed into the third basket, for example, the third basket 112 (Basket 3) at block 1018A. The lowest point of the clothing item(s) may refer to the portion of the clothing items most distant from the hand 208 of Arm 1. At block 1020, a second robotic arm 202 (Arm 2) grabs one lowest point of the clothing item(s). At block 1022, Arm 2 lifts the clothing item to the highest level. Arm 1 then releases the clothing item(s) at block 1024. As only one lowest point is grabbed at block 1018, even if Arm 1 grabs more than one clothing item, it is very unlikely that multiple clothing items will be grabbed by Arm 2 for folding at block 1024. At block 1026, the type of the clothing item grabbed by Arm is identified by an artificial intelligent (AI) system.

At block 1026, an artificial intelligence (AI) system may be used to confirm that a single clothing item remains being grabbed by Arm 2. The AI system is trained to identify the types of clothing items based on the characteristics of the clothing items. For example, a clothing item with a main body and two sleeves connected to two opposite sides of the main body is recognized as a top such as a T-shirt, a shirt, or a sweater, or other clothing items with sleeves. In addition to the sleeves at two opposite sides of the main body, the open tops at all locations of the clothing items may also be used to determine the types by the AI system. For example, a clothing item with a length no longer than a predetermined value and having two small openings at two opposite sides and a large opening at the bottom of a main body may be considered as a sleeveless top. A clothing item with two small openings or sleeves at two opposite sides near a top portion and a large bottom opening that has a length longer than the predetermined value may be considered as a dress. A rectangular clothing item with four straight sides and four right corners is recognized as a towel. A clothing item with a main body and two legs extending from the same side of the main body is considered as a bottom. The bottom is recognized as a pair of shorts when the length of the extended portions is no longer than a predetermined value, otherwise, the bottom is recognized as a pair of pants. A clothing item with an open top and a single open bottom may be considered as a skirt.

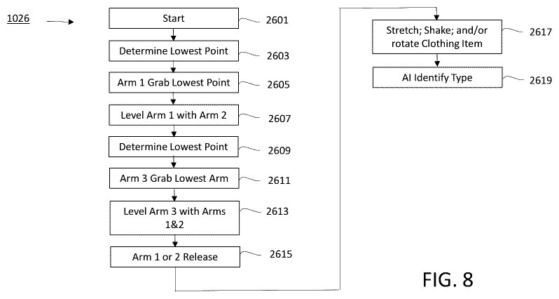

FIG. 8 is a block diagram showing various steps of a method to identify a clothing item at block 1026 of FIG. 7. When it is determined that only one clothing item is grabbed by Arm 2 at block 1024 of FIG. 7, the process of identifying the clothing item starts at block 2601. At block 2603, one lowest point of the clothing item is determined. Arm 1 (or another free arm) is driven to grab the lowest point at block 2605. Arm 1 is then driven to move at the same height as Arm 2. That is, at block 2607, Arm 1 is level with Arm 2. At this stage, two portions of the clothing item are grabbed by Arm 1 and Arm 2 at the same height with at least two portions dangling under the two grabbed portions. At block 2609, one lowest point of the dangling portions is determined. The lowest point of the dangling portions is then grabbed by a third arm 202 (Arm 3) at block 2611. It will be appreciated that, even if two portions of the dangling portions are at the same height, Arm 3 will grab only one of the lowest points at block 2611. Arm 3 is then driven to level with Arm 1 and Arm at block 2613. At block 2615, either Arm 1 or Arm 2 releases the clothing item, leaving two points of the clothing item grabbed by the mechanical arms (Arm 3 and Arm 1 or Arm 2). Arm 3 and Arm 1 (or Arm 2) moves to stretch and shake the clothing item at block 2617. The engaging Arms 3 and 1 or 2 may also rotate the clothing item to allow the cameras to capture the images from different angles. The AI system may then determine the type of the clothing item at block 2619.

FIG. 9 shows a method 2000 for folding various types of clothing items. The method starts with identifying the clothing item currently grabbed by the four robotic arms 202 at block 2001, which is the same as block 1026 of FIG. 7 and block 2623 of FIG. 8. In case the type of the clothing item cannot be identified, the unidentified clothing item may be placed into Basket 3 at block 2002. For example, when the clothing item cannot be identified, three of the robotic arms 202 may release the points being grabbed thereby, and the remaining robotic Arm 202 may be driven to move and release the clothing item into Basket 3 at block 2003. As shown in FIG. 9, the method 2000 includes a plurality of subroutines for folding different types of clothing items. For example, once the type of the clothing item is identified as a top with sleeves, the routine at block 2100 is executed. Similarly, the process flows to blocks 2200, 2300, 2400, 2500, 2600, 2700, and 2800 when the clothing item is identified as a sleeveless top, a pair of shorts, a pair of long pants, a large towel, a small towel, a pair of underpants, and other items, respectively. It will be appreciated that the various routines are exemplary and not exclusive. When a new type of clothing item is added into the identifiable lists of clothing items the AI system, the processor that controls the robotic arms 202 and the folding mechanism 300 may be programmed to facilitate the folding operation of the newly identifiable clothing item. According to some embodiment, the folding machine 100 may include a motherboard or a minicomputer where the processor and the AI system are arranged. The motherboard may also provide wireless network such as Wi Fi connection. For example, the folding machine 100 as shown in FIG. 2 includes a minicomputer 201 installed in or outside of the box 200.

The method and mechanism as shown in FIGS. 1-9 facilitate automatic sorting, identifying, and folding multiple types of clothing items within a single folding machine. According to some embodiments, after the type of each clothing item has been identified, the specific types of clothing items may be placed in individual drawers before being folded. The clothing items in each drawer may be folded within the same machine or output to an external folding machine. The external folding machine may include the same folding mechanism as shown in FIGS. 1-6 or different folding mechanisms. The number of output drawers or baskets may be increased. For example, the folding machine may include a drawer for tops, a drawer for shorts/under pants, a drawer for long pants, a drawer for towels, a drawer for bras, and a drawer for others, for example, unidentifiable clothing items. In industries such as hotels, department stores, military units, or other institutions where laundry for some specific type of clothing is significantly more demanded than others, the drawer for storing certain identified clothing items may be designed with larger capacity than others. For example, in the hotel industries where laundry of a large amount of towels is a daily task, the drawer or basket for storing the towels may be significantly larger than those for other types of clothing items. The identified towels may be manually or automatically delivered to the built-in folding mechanism or an external towel folding structure.

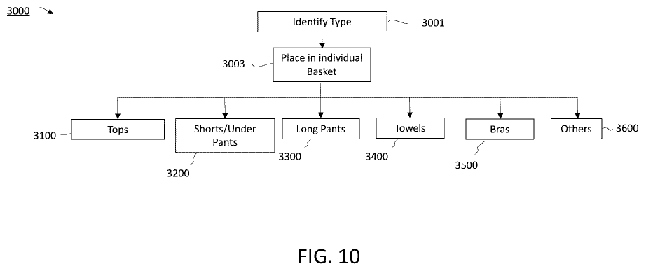

In the embodiment as shown in FIG. 10, once the clothing item is identified at block 3001, the identified clothing item is placed in the designated storing basket or drawer waiting to be folded. The selected type of clothing items may then be folded by the built-in folding mechanism or delivered to an external folding mechanism at each of blocks 3100, 3200, 3300, 3400, 3500, and 3600. The number of baskets may vary according to specific needs. For example, additional baskets for separating the tops with and without sleeves, for separating small towels and large towels, and for separating the shorts and underpants as shown in FIG. 9 may be included too. In some embodiments, a basket for storing bed sheets, skirts, and other bedding items may also be included. This allows the folding machine to select one folding procedure until all the clothing items of the same type have been folded before selecting another folding procedure. Moreover, as the types of clothing items may be delivered to individual folding machines, different types of clothing items may be folded at the same time.

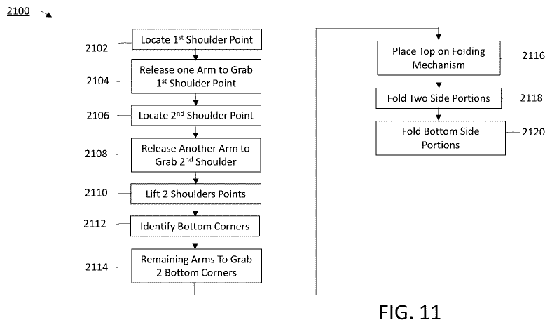

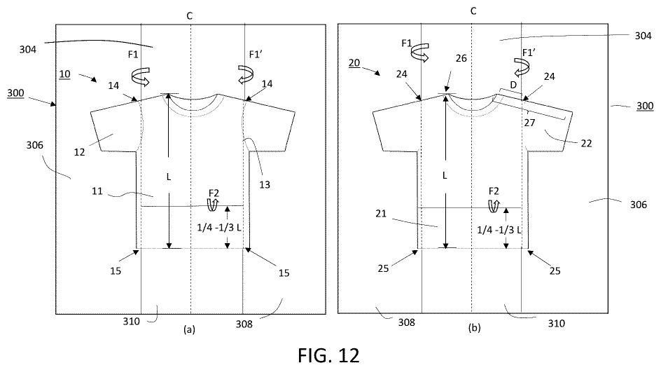

When the clothing item is identified as a top with two sleeves, a folding method 2100 may be performed as shown in FIGS. 11, FIGS. 12(a) and 12(b). In FIG. 12(a), the top 10 has two seams 13 where the sleeves 12 joined the main body 11. In FIG. 12(b), the sleeves 22 extend from the main body 11 without connecting seams. The method will be described with reference to the schematic drawings of a top 10 on the folding mechanism 300 in FIG. 12(a) and the schematic drawings of a top 20 on the folding mechanism 300 in FIG. 12(b). At block 2102, a shoulder point of the top 10 is located. One of robotic arms 202 releases the point of the top currently grabbed by this arm to grab the shoulder point at block 2104. At block 2106, another shoulder point is located, and another arm releases the point currently grabbed thereby and grabs the second shoulder point at block 2108. In the embodiment as shown in FIG. 12(a), the top 10 includes two sleeves 12 joined with the main body 14 with two seams 13. The tops of the seams 14 may/be defined as the shoulder points 14 at blocks 2012 and 2016. In the embodiment as shown in FIG. 12(b), the sleeves 22 extend from a top portion of the top 20 without any seam. The shoulder points 24 may be defined as a point with a distance D away from two edge tips 26 of a neck portion along the shoulder 27 of the top 20. The distance D varies with the width of the neck portion of the top 20.

At block 2110, the shoulder points of the top 10 (20) are lifted to a higher level. At block 2112, two bottom corners 15 of the top 10 (25 of the top 20) are located. The remaining two robotic arms 202 then release the currently grabbed portions at block 2114. At block 2116, the top 10 (20) is then placed on the folding mechanism 300. According to some embodiment, while placing the top 10 (20) on the folding mechanism 300, the central axis of the top 10 (20) may be aligned with the central axis C of the central board 304 of the folding mechanism 300 to achieve a symmetric folding operation. The central axis C may be marked on the central board 304. Alternatively, the mark of the central axis C may extend through both the central board 304 and the front folding board 310 such that the alignment may be easily achieved. In addition, as shown in FIG. 12, the top 10 (20) may be placed with an upper portion on the central board 304 and a lower portion on the front folding board 310. For example, one third (⅓) or one fourth (¼) of the length L of the top 10 (20) may be placed on the front folding board 310, while the other two third (⅔L) or three fourth (¾L) may be placed on the central board 304 at block 2116.

At block 2118, the side folding board 306 is driven to flip over the central board 304 as shown by the arrow F1. As discussed above, the front folding board 310, the side folding board 306, and the side folding board 308 may be processed with a roughened surface or covered with a thin coating layer to prevent the clothing item from slipping during the folding operation. However, the clothing item will be stuck with the roughened surface or coating when the clothing item is placed thereunder. The side folding board 306 is then driven to flip back side-by-side with the central board 304. The other side folding board 308 is then driven to flip over the central board 304 as shown by the arrow F1′, and then flip back to the side-by-side position with the central board 304. At block 2120, the front folding board 310 is then driven to flip of the lower ¼-⅓ of the main body 11 (21) over the upper portion of the main body 11 (21) on the central board 304 as shown by the arrow F2. The folded top 10 (20) is then placed into the storage basket, for example, basket 120, at block 2005.

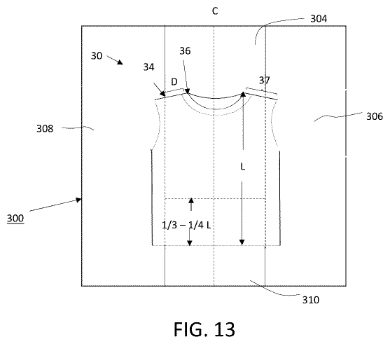

The procedure 2200 for folding a sleeveless top may be the same as the procedure 2100 for folding the top 20 that does not have seams between the main body 21 and the sleeves 22. For example, as shown in FIG. 13, the shoulder points 34 may be located at two points of the shoulder 37 with a distance D from two ends 36 of the neck opening of the sleeveless top 30. The distance D may range from 0 to a few inches depending on the side of the neck opening.

The folding mechanism can be programmed with different folding procedures for folding different clothing items. For example, to fold a pair of shorts, the procedure 2300 may use the AI system and the cameras 124 to determine the side seams or central seams of the shorts or any specific part such as the top and bottom open edges of the shorts. Once the seam is determined, the robotic arm 202 may place the shorts on the folding platform 300 with the seam aligned with a desired line, for example, the joint between the central panel 304 and any of the side panels 306, 308, and the front panel 310. The folding panels 306, 308, and 310 may then be flapped over and away from the central panel 310 with a specific sequence as programmed.

The procedures 2400, 2500, 2600, 2700, or 2800 may also use the cameras 124 and the AI system to determine a specific position of the respective clothing items and align the specific position with a desired location on the folding platform 300 with the robotic arms 202. The side panels 306, 308, and front panel 310 are then flapped over and away from the central panel 310 according to the respective sequences as programmed.

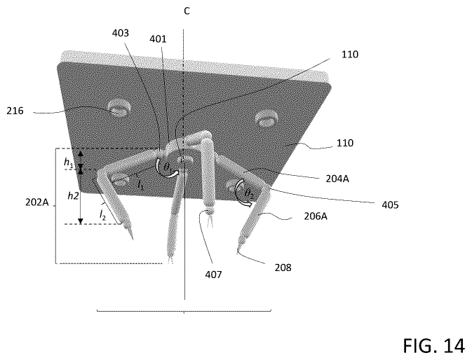

FIG. 14 shows the robotic arms according to another embodiment of a folding machine. As shown in FIG. 14, four robotic arms 202A radially extending from a structure 400 mounted to the top panel 100 of the folding machine. The structure 401 may rotate or spin about a center axis C that extends perpendicular to and through a center point of the top panel 110. The rotation of the structure 401 may thus drive the robotic arms 202A about the central axis C. Each of the robotic arms 202A includes an upper arm 204A and a (lower arm) forearm 206A. Each of the upper arms 204 may include an upper end radially extending from to the structure 400. In some embodiments, the upper end of each upper arms 204A may be pivotally connected to the structure 401 with similar pivotal structure as shown in FIG. 2. Alternatively, a joint 403 may be used to connect the upper ends of the upper arms 204A to the structure 401 to the upper arms 204A to allow the upper arms 204A to bend between two horizontal planes in parallel with the top panel 110. In other words, the lower end of each upper arm 204A may move to and from the level where the joint 403 is with a distance h₁ with an angle θ₁ with respect to the central axis C. The height difference h₁ and the angle θ₁ may be configured based on the dimension of the cavity or the length of the clothing items to be folded. The length l₁ of the upper arms 204A may thus have a relationship with the bendable height h₁ as “h₁=l₁·cos θ₁. Each of the lower arms 206A may have an upper end connected to the corresponding upper arm 204A by a joint 405 according to some embodiments. The upper arm 204 and the forearm 206A can thus be bent with an angle θ₂ with respect to each other. The angle θ₂ reflects to the relative orientations of the upper arm 204A and the forearm 206A. The length l₂ of the forearms 206A may be the same or longer than the length l₁ of the upper arm 204A.

The driving mechanism of the robotic arms 202A may be the same as those described with reference to FIG. 2. pivot 210 may be connected to and driven by a motor or other mechanisms to spin or rotate. The bottom end of each of the forearm 206A may be connected to a hand with a joint 407. The hand may include at least two fingers 208 for grabbing, retaining, and releasing the clothing items to and from each of the baskets 118, 120, and 122.

In some embodiments, the fingers 208 operate in a pincer-like alignment motorized to enable opening and closing motions. Both the upper arms 204A and the forearm 206A may be hollow to allow wirings connected to a motor and each of the fingers 208. Other electric and mechanical arrangement that drive the relative movements of the upper arms 204A and the forearms 206A may also be used.

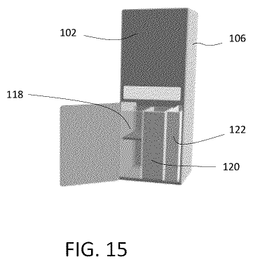

As the robotic arms 202A extend within the distance h₁+h₂ below the top panel 110, the clothing items disposed in any of the baskets 118, 120, and 122 under this height range may be inaccessible to the robotic arms 202A. According to some embodiments, the baskets 118, 120, and 122 may be configured to moveable between the loading and unloading position and the operation level where the robotic arms 202A may reach clothing items as shown in FIG. 15. The moveable feature may be achieved by any structure or method such as hydraulic system, electromagnetic system, or other systems.

According to some embodiments, the baskets 118, 120, and 122 may move to different heights or levels within the folding machine 100 for different operations. For example, the baskets 118, 120, and 122 may be placed at a first height for loading and/or unloading clothing items. As shown in FIG. 15, when the robotic arms 202A cannot stretch to the bottom portions of the folding machine, the basket 118 may be driven to an upper level where the robotic arms 202A may access the clothing items placed therein. The movement of the baskets 118, 120, and 122 may be achieved by using hydraulic mechanism, electromechanical mechanism, other traditional mechanical structure, or any suitable driving mechanism.

According to one embodiment, a machine is provided. The machine comprises an enclosure, three or more robotic arms each having one end connected to a top panel of the enclosure and an opposite end connected a hand configured to grab and release one or more clothing items, two or more baskets for storing the clothing items, a folding platform above the baskets, a processor, and an artificial intelligence system. The folding platform may include a central board with one side hinged with a sidewall of the machine and one folding board hinged with each of three free sides of the central panel. The processor is configured to control movement of each of the robotic arms, while the artificial intelligence system is configured to identify each item grabbed by at least one of the robotic arms.

Each of the robotic arms may comprise a first arm portion extendable and retractable and rotatable about a point on a plane in parallel with the top panel and a second arm portion extendable from and retractable towards the first arm portion. Each of the second arm portions may include a plurality of segments telescoped with each other. The hand may be pivotally connected to the opposite end of the corresponding second arm portion. Each of the hands may further include two or more fingers for grabbing at least one clothing item in either one of the baskets. The fingers may include two or more straight or curved pins operable to open and close to grab the clothing items. In some embodiments, the fingers may include one or more bendable segments joined with each other. The second arm portions are extendable and retractable between a rest position above the folding platform and a bottom of each of the baskets. The machine may further comprise a plurality of cameras to capture images of clothing items grabbed by the robotic arms.

In some embodiments, the processor is configured to control a first robotic arm to grab clothing items from one of the baskets and lift the clothing items to a predetermined height. The cameras are controlled to capture images of the clothing items to locate a lowest point of the clothing items grabbed by the first robotic arm. The processor then controls the second robotic arm to grab the lowest point of the clothing items and lift the lowest point to the predetermined height. The first robotic arm is then controlled to release the clothing items grabbed thereby. The processor is further configured to control locate a lowest point of the remaining clothing item grabbed by the second robotic arm and control the first arm to grab the lowest point of the remaining clothing item. The type of the remaining clothing item is then identified by the artificial intelligent system.

The processor may further be configured to locate a lowest point of the remaining clothing item grabbed by both the first and second robotic arms and control a third robotic arm to grab the lowest point. The remaining clothing item may then be rotated to allow images thereof to be captured from various angles to assist the AI system to identify the type of the remaining clothing item.

The processor may also be configured to control the folding platform to swing to a folding position from a rest position and the robotic arms to place the clothing item identified by the AI system on the central board. The side folding boards to fold portions of the clothing item outside of the central board over the central board in a sequence determined by the type identified by the AI system. The clothing item may be placed on the folding platform with a predetermined portion of the clothing item aligned with a predetermined position of the central board. The AI system may comprise an image processor and a database storing characteristics of a plurality of clothing items. Each of the side folding boards includes a rough surface to prevent a clothing item from slipping during folding.

According to another embodiment, a machine is provided. The machine comprises two or more robotic arms. Each of the robotic arms comprises a first arm portion extending along a first direction and rotatable about a point, a second arm portion with a first end joined with of the first arm portion and extending along a second direction perpendicular to the first direction, and a hand portion joined with a second end of the second arm portion. The machine includes two or more baskets able to move in and at least partially out of the machine are included. A processor is included and configured to control a first robotic arm to extend into one of the baskets to grab clothing items therefrom and lift the clothing items to a height above the baskets; one or more cameras to locate a lowest point of the clothing items grabbed by the first robotic arm; a second robotic arm to grab the lowest point and lift the lowest point to the predetermined height; the first robotic arm to release the clothing items grabbed thereby; the one or more cameras to locate a lowest point of the remaining clothing item grabbed by the second robotic arm; the first robotic arm to grab the lowest point of the remaining clothing item and lift the lowest point of the remaining clothing item; and the AI system to identify a type of the remaining clothing item. The machine may further comprise a folding platform hinged with a sidewall, wherein the folding platform is positioned in a rest position out of a path where the robotic arms move before the type of the remaining clothing item is identified and positioned to a folding position above the baskets after the type of the remaining clothing item is identified.

In another embodiment, a machine is provided. The machine includes an enclosure, at least two baskets, four robotic arms, a folding platform, a processor, and an AI agent. The enclosure comprises a top panel, bottom panel, and four side panels. The baskets includes a first basket for storing unfolded clothing items and a second basket for storing folded clothing items. Both the first and second baskets are openable for loading and unloading the clothing items. The four robotic arms each comprising an upper arm radially extending from a pivot; a lower arm extendable into the baskets; and a hand for grabbing the clothing items stored in the first basket and placing the clothing items into the second basket. The processor is configured to control the four robotic arms to grab one or more clothing items from the first basket; select and grab only one of the clothing items from the first basket. The AI agent is configured to identify a type of the only one clothing item. The folding platform is configured to fold the clothing items identified by the AI agent in a manner based on the type of identified by the AI agent.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A machine, comprising:
an enclosure;
three or more robotic arms each having one end connected to a top panel of the enclosure and an opposite end connected a hand configured to grab and release one or more clothing items;
two or more baskets for storing the clothing items;
a folding platform above the baskets, comprising;
a central board with one side hinged with a sidewall of the machine; and
one folding board hinged with each of three free sides of the central panel;
a processor, configured to control movement of each of the robotic arms; and
an artificial intelligence (AI) system, configured to identify each item grabbed by at least one of the robotic arms.

2. The machine according to claim 1, wherein each of the robotic arms comprising:
a first arm portion extendable and retractable and rotatable about a point on a plane in parallel with the top panel; and
a second arm portion extendable from and retractable towards the first arm portion.

3. The machine according to claim 1, wherein each of the second arm portions includes a plurality of segments telescoped with each other.

4. The machine according to claim 1, wherein the hand is pivotally connected to the opposite end of the corresponding second arm portion.

5. The machine according to claim 1, wherein each of the hands further includes two or more fingers for grabbing at least one clothing item in either one of the baskets.

6. The machine according to claim 4, wherein the fingers include straight or curved pins operable to open and close to grab the clothing items.

7. The machine according to claim 1, wherein each the fingers includes one or more bendable segments joined with each other.

8. The machine according to claim 1, wherein each of the second arm portion is extendable and retractable between a rest position above the folding platform and a bottom of each of the baskets.

9. The machine according to claim 1, further comprising a plurality of cameras to capture images of clothing items grabbed by the robotic arms.

10. The machine according to claim 9, wherein the processor is configured to:
control a first robotic arm to grab clothing items from one of the baskets;
control the first robotic to lift the clothing items to a predetermined height;
control the cameras to capture images of the clothing items;
locate a lowest point of the clothing items grabbed by the first robotic arm based on images captured by one or more of the cameras;
control the second robotic arm to grab the lowest point of the clothing item and lift the lowest point to the predetermined height; and
control the first robotic arm to release.

11. The machine according to claim 10, wherein the processor is configured to:
control the cameras to capture images of the clothing item grabbed by the second robotic arm;
locate a lowest point of the remaining clothing item grabbed by the second robotic arm based on images captured by the one or more camera;
control the first arm to grab the lowest point of the remaining clothing item; and
identify a type of the clothing item using the AI system.

12. The machine according to claim 11, wherein the processor is configured to:
locate a lowest point of the remaining clothing item grabbed by both the first and second robotic arms;
control a third robotic arm to grab the lowest point of the remaining clothing item grabbed by the first and second; and
rotate the remaining clothing item for the cameras to capture images from a plurality of viewing angles.

13. The machine according to claim 12, wherein the processor is configured to:
control the folding platform to swing to a folding position from a rest position;
control the robotic arms to place the clothing item identified by the AI system on the central board; and
control the side folding boards to fold portions of the clothing item outside of the central board over the central board.

14. The machine according to claim 13, wherein the processor is configured to align a predetermined portion of the clothing item with a predetermined position of the central board.

15. The machine according to claim 1, wherein the AI system comprises an image processor and a database storing characteristics of a plurality of clothing items.

16. The machine according to claim 1, wherein each of the side folding boards includes a rough surface to prevent a clothing item from slipping during folding.

17. A machine, comprising:
two or more robotic arms, each comprising:
a first arm portion extending along a first direction and rotatable about a point;
a second arm portion with a first end joined with of the first arm portion and extending along a second direction perpendicular to the first direction; and
a hand portion joined with a second end of the second arm portion;
two or more baskets, each being configured to move in and at least partially out of the machine; and
a processor, configured to control:
a first robotic arm to extend into one of the baskets to grab clothing items therefrom and lift the clothing items to a height above the baskets;
one or more cameras to locate a lowest point of the clothing items grabbed by the first robotic arm;
a second robotic arm to grab the lowest point and lift the lowest point to the predetermined height; and
the control robotic arm to release the clothing items grabbed thereby;
the one or more cameras to locate a lowest point of the remaining clothing item grabbed by the second robotic arm;
the first robotic arm to grab the lowest point of the remaining clothing item and lift the lowest point of the remaining clothing item; and
the AI system to identify a type of the remaining clothing item.

18. The machine according to claim 17, further comprising a folding platform hinged with a sidewall, wherein the folding platform is positioned in a rest position out of a path where the robotic arms move before the type of the remaining clothing item is identified and positioned to a folding position above the baskets after the type of the remaining clothing item is identified.

19. A machine, comprising:
an enclosure, comprising a top panel, bottom panel, and four side panels;
at least a first basket for storing unfolded clothing items and a second basket for storing folded clothing items, wherein the first and second baskets are openable for loading and unloading the clothing items;
four robotic arms each comprising:
an upper arm radially extending from a pivot;
a lower arm extendable into the baskets; and
a hand for grabbing the clothing items stored in the first basket and placing the clothing items into the second basket;
a folding platform for folding the clothing items;
a processor configured to control the four robotic arms to:
grab one or more clothing items from the first basket;
select and grab only one of the clothing items; and
an artificial intelligence agent configured to identify a type of the only one clothing item.

20. The machine according to claim 19, wherein the folding platform includes a central board with one side hinged with the one of the side panels and three other sides hinged with three side folding boards flipped over the central board in a sequence based on the type identified by the artificial intelligence agent.
